(19) United States
(12) Patent Application Publication
(10) Pub. No.: US 2013/0124567 A1
(43) Pub. Date: May 16, 2013

(54) AUTOMATIC PRIORITIZATION OF POLICIES

(71) Applicants: Helen BALINSKY, Cardiff Wales (GB); Neil Moore, Lancashire (GB); Steven J. Simske, Fort Collins, CO (US)

(72) Inventors: Helen BALINSKY, Cardiff Wales (GB); Neil Moore, Lancashire (GB); Steven J. Simske, Fort Collins, CO (US)

(21) Appl. No.: 13/295,935

(22) Filed: Nov. 14, 2011

(51) Int. Cl. G06F 17/30

(52) U.S. Cl. 707/783; 707/E17.005

(57) ABSTRACT

Input is obtained to modify one of a set of self-consistent and prioritized document policies, each policy indicating an allowability of a requested action when a condition of the policy is satisfied. Each policy is representable by a node on a multipartite graph, the node being located in a part of the multipartite graph that corresponds to the allowability indicated by the policy. Two nodes are connectable by an edge that indicates a relative priority between their corresponding policies. A transitive closure of the representation is computed so as to identify paths of contiguous edges that connect pairs of nodes. When two policies with different allowabilities are applicable to a single requested action on a single document, and when the corresponding nodes are connected by one of the identified paths, a relative priority is automatically assigned to the two policies as indicated by the path.

### BACKGROUND

Recent advances in document creation and management technologies include collaborative creation and editing of documents, automatic repurposing tools, document-centric workflows, and online document sharing. Cloud computing and mobility have merged secure intranets and a generally insecure Internet making it become more simple for a participant to drag-and-drop protected data into a publicly accessible document, possibly even without realizing it. Thus, document access control based on information about a document alone (document level metadata) may be insufficient to prevent leakage of, or provide for adequate management of, sensitive data. Such document level metadata could fail to transfer to or properly describe such a newly created or modified document.

For this reason, context-aware policies have been developed for document management and access control. Such context-aware policies take into account the actual (run-time) document contents at the moment a document action is about to be executed. Policy conditions of context-aware policies may include document keywords, data patterns, regular expressions, or any combination thereof, or any other condition verifiable on a document and at the same time inherent to a particular type of sensitive data. For example, a document to be exported may be analyzed in light of the context-aware policies, and if a condition of a policy is satisfied, then protective action defined by the policy may be triggered. In this manner, an inadvertent (unintentional) leak of sensitive data may be avoided.

A policy may consist of specification of an action to which it is applicable, a policy condition, and possible policy exceptions. For example, an action to which it is applicable may include transferring a document transferring to a Universal Serial Bus (USB), or sending by e-mail. A single policy may be applicable to more than one action, or more than one policy may be applicable to the same action. A policy condition may include several conditions combined by Boolean operations such as AND, OR, or NOT. Policy exceptions may specify when a policy does not apply. For example, a policy could forbid sending an e-mail containing confidential information to all addresses except internal (e.g. within a company or organization) e-mail addresses.

It is expected that documents that issue from a single source (e.g. a single business or a single template) will have common content, relating to the same subjects and topics. Yet, only some of these related documents may contain sensitive content that may be distinguished by conditions of policies. In addition, a natural language may include many ways to express a single concept or subject. Thus, a policy may be made to be sufficiently flexible so as to accommodate potential variations (e.g. synonyms or semantic equivalences) as well as language inflections or spelling errors. Context-aware policy conditions may therefore, incorporate alternatives, negations, and variants.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 schematically illustrates an example of a system for automatic assignment of priorities to policies;

FIG. 2A is a graphical representation of ordering of a set of policies for an example of automatic prioritization of policies;

FIG. 2B is a graphical representation of a reduced form of the graph shown in FIG. 2A;

FIG. 3 is a flowchart of an example of a decision process by application of a set of policies;

FIG. 4 is a flowchart of an example of a method for automatic prioritization of policies; and

FIG. 5 is a flowchart of an example of a method for automatic prioritization of policies upon adding a policy to a set of policies.

### DETAILED DESCRIPTION

In accordance with an example of the automatic prioritization of policies, allowability of execution of a requested or proposed (e.g. by a user or by an automatic application) action on a document file (herein referred to interchangeably as a document) or a set of documents may be determined by an enforcement mechanism that bases its decision at least partially on a set of policies, such as context-aware policies. Allowability of the action may include enabling (allowing) the action as requested, enabling the action in modified form (e.g. requiring performance of another action prior to enabling the requested action, or disabling (denying) the action. Other policies that are not context-aware policies may also be applied by the policy decision mechanism.

Application of a policy of the set may yield an indicated allowability with regard to the requested action, depending on satisfaction of a condition of that policy. The policy condition may include a plurality of individual sub-conditions, all or some of which need to be satisfied in order for the policy condition to be satisfied. Some or all of the individual sub-conditions may be based on the content of the document (e.g. a text tag, a text string, symbol, or other document content). An individual sub-condition of the policy condition may be based on factors other than document content, e.g. document file metadata or document layout structure, application, workflow, device, location, permissions of the user, distinct jurisdictional or other regulations.

Context-aware policies need not be mutually exclusive (unlike some other types of security policies). For example, a single document may simultaneously contain keywords that relate to conditions of two different policies with different allowabilities. In such a case, a decision may be required regarding which of the two policies is to be applied to the requested action on the document. (Although policies may be made mutually exclusive by increasing the complexity of the conditions, it may be difficult for a human policy administrator to effectively comprehend and manage such complex conditions or anticipate the adequacy of the protection.) When the application of two or more policies to a single requested action on a single document results in mutually contradictory allowabilities (e.g. application of one policy may indicate enable an action while application of the other may disable the action), a priority may be assigned to each of the policies. Thus, when evaluating execution of an action on a document in light of a set of applicable context-aware policies wherein application of two or more policies yields mutually contradictory results, allowability of the requested action may be the allowability that is indicated by application of the policy that was assigned the highest priority.

The set of policies may be maintained such that the set remains self-consistent. A set of policies is herein considered to be self-consistent if the application of policies of the set (or application of a selected subset of relevant policies) to a single requested action on a single document always results in an unambiguously determined allowability (without mutually incompatible, contradictory, or ambiguous results). For example, it may be assumed that the set of policies is initially self-consistent, e.g. free of inconsistencies and ambiguities. An example of set of policies that is initially self-consistent is a set of policies that was initially empty (such that no inconsistency or ambiguity was possible). It may be further assumed that whenever a policy was added to the set (or deleted or modified), methods described herein or other methods were applied such that the set remained self-consistent.

When the set of policies is to be modified (e.g. when a policy is to be added to the set, deleted from the set, or edited), policies of the set may be examined in light of the modification so as to determine mutual compatibility between pairs of the policies. When an incompatible pair of policies is found (e.g. capable of yielding mutually contradictory results), a priority of at least one of the policies of the pair may be adjusted. Adjustment of policy priorities may include soliciting or receiving input from an administrator, e.g. in the absence of sufficient information to enable automatic adjustment of the priorities.

In accordance with an example of automatic prioritization of the policies, relative priorities may be automatically assigned to at least some pairs of policies. Thus, the number of policies pairs whose prioritization requires input from the administrator may be reduced.

A set of policies may be represented in a form that corresponds to a graphical form. In the corresponding graph, each policy of the set may be represented by a node.

A transitive closure may be computed for the representation. The representation may be graphically represented as a multipartite graph that is divisible into a plurality of regions, herein referred to as parts. Each part of the graph may correspond to an allowability result, or other result of application of a policy. For example, a representation with of a set of policies with two allowabilities, e.g. allow and deny, may be graphically represented as a bipartite graph. Each part of the bipartite graph corresponds to one of the types of allowabilities. A node may be located in a part of the multipartite graph that corresponds to the allowability of that policy (when applicable and its condition is satisfied).

In order to automatically prioritize policies when the set of policies are modified, a modification may be incorporated into the representation. For example, when a policy is added, a node that corresponds to the added policy may be added to the appropriate part of the graph (corresponding to the allowability of the added policy). When a policy is deleted or removed from the set, the node that corresponds to the removed policy may be deleted from the representation. When editing a policy, properties of a node corresponding to the edited policy, or placement of the node, may be similarly modified. Alternatively, a representation of editing of a policy may be divided into two steps: first removing the node that corresponds to the policy prior to editing, then adding a node that corresponds to the edited policy.

Automatic analysis of the representation may enable automatic assignment of relative priorities to a pair of policies. For example, two policies that indicate different allowabilities may be applicable to a single requested action on a single document where the conditions of both of the policies may be concurrently satisfiable.

For example, application of one policy to a requested action on a document may indicate that the action is allowed, while application of the other may indicate that the action is rejected. In this case, the two policies may be represented by nodes in different parts of a bipartite or multipartite graph. In such a case, a relative priority is to be assigned. Such a relative priority may be graphically represented by an edge (e.g. a directional edge, the direction being represented, e.g., by an arrow) that connects that the two nodes that correspond to the two policies. If analysis of the graph (e.g. computing a transitive closure) indicates that a path of one or more contiguous edges exists between the two nodes, a priority indicated by the path may be considered as existing (due to the transitive nature of the policies) and no additional edge need be assigned (e.g. via solicitation of input from a policy administrator). Two edges of a path may be considered contiguous when a leading end of one of the edges and a trailing end of the other edge connect to a common node. (A path consisting of a single edge is herein also referred to as a contiguous path.)

When no such path of contiguous edges connects the two nodes, an edge must be added. For example, input from a policy administrator may be solicited so as to assign a relative priority to the two policies. As another example, an automatic application may assign priorities (e.g. based on a statistical analysis of policies of the set), or a combination of administrator input and an automatic application may enable assigning priorities.

For example, a context-aware policy may determine that a particular requested action may or may not be performed with regard to a document whose content includes one or more particular text strings. Thus, a computer or processor that is programmed or configured to run in accordance with the set of policies may not be enabled to perform an operation or action with regard to a document file unless that action is enabled in accordance with the policies of the set. Actions with regard to a document that may be enabled or disabled in accordance with context-aware policies may include, for example among other actions, sending (e.g. by email), uploading, editing, printing, copying, deleting, or saving.

A condition of a context-aware policy may also be dependent on factors in addition to content of the document. For example, a dependency on metadata may limit application of a policy regarding printing to a particular printer or set of printers. Similarly, a condition regarding sending an e-mail may limit application of the policy to sending email to a particular email address, set of email addresses, or domain. A condition regarding uploading a file may limit application of the policy to a particular Internet Protocol (IP) address or set of IP addresses, and a condition regarding saving may limit application to a particular save path or set of save paths (e.g. from an original location to an intended destination). In addition, a policy may enable (allow) or disable (deny) an action subject to a limitation or embellishment (e.g. a required concomitant action). Examples of such embellishments may include, for example among others, logging, alerting, encrypting, requesting a formal authorization for the action, signing, or redacting.

Application of context-aware policies as described herein may enable making a quick and accurate decision when a user attempts to export data. Policies may be evaluated and applied quickly and accurately, e.g. in response to a user-requested action (e.g. pressing a Send button). Until the request and data are analyzed in light of the set of policies, the requested action may be suspended to prevent an undesirable consequence (e.g. leaking data). When application of the set of policies results in a decision, either the originally requested action, an embellished (e.g. by addition of an additional action, such as encryption) action is executed, or the action is denied (e.g. with a message sent to the user who requested the action). A decision regarding the user requested action may be attained in real/run-time, e.g. without the user noticing any delay when the action is allowed.

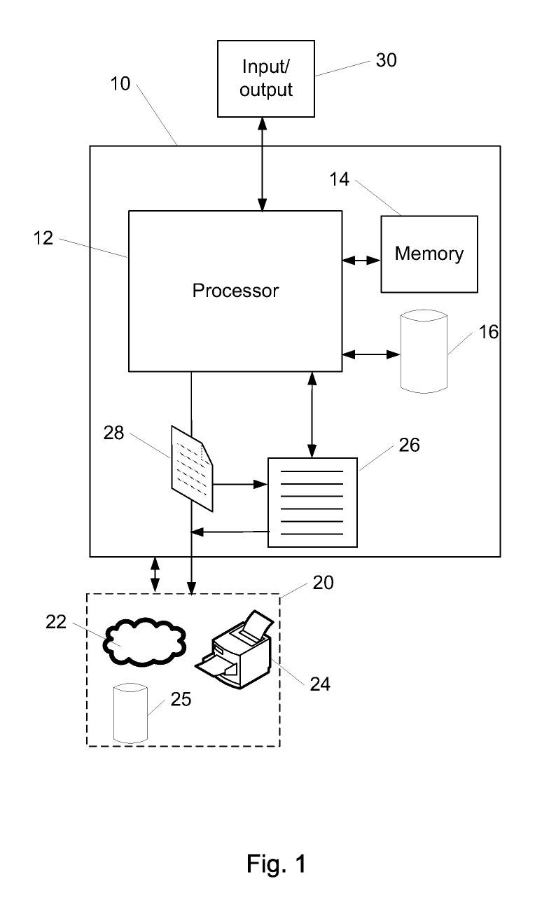

FIG. 1 schematically illustrates an example of a system for automatic assignment of priorities to policies. Automatic priority assignment system 10 may include one or more computers (e.g. connected by a network), or may include one or more modules or applications that may be run on one or more computers. The computers may be incorporated in another system, such as a network server or a document management system. For example, automatic priority assignment system 10 may include one or more computers to be operated by a policy administrator (herein referring to a person or application who interacts with the system in order to create or manage policies), and one or more separate computers to be operated by a user (herein referring to a person or application who interacts with the system to request actions to be executed on documents, automatically causing application of policies).

Automatic priority assignment system 10 includes processor 12 which may operate in accordance with programmed instructions. Processor 12 may communicate with a memory 14. Memory 14 may include one or more volatile or non-volatile memory devices, such as a random access memory (RAM). For example, memory 14 may be used to store programmed instructions or data for operation of processor 12, such as one or more sets of policies 26 or one or more documents 28. Processor 12 may also communicate with data storage device 16. For example, data storage device 16 may include one or more fixed or removable non-volatile devices that may be used for storing data, such as programming instructions for operation of processor 12, one or more sets of policies 26, or one or more documents 28.

Processor 12 may communicate with input/output device 30. Input/output device 30 may include one or more output devices, which may include, for example, a display or an audio output device. For example, an output device of input/output device 30 may be operated to communicate information to a user, administrator, or operator of automatic priority assignment system 10. Input/output device 30 may include one or more input devices, such as a keyboard or keypad, a pointing device, touch screen, a video input device, or an audio input device. For example, an input device of input/output device 30 may be operated by a user, administrator, or operator of automatic priority assignment system 10 in order to enter an instruction or selection to processor 12.

Processor 12 may communicate with export devices 20. For example, export devices may include a network 22, a printer 24, or a (e.g. non-secure) storage device 25. Processor 12 may be instructed, e.g. via input/output device 30, to perform an action on document 28 that exports document 28 to export devices 20. Policies 26 may be applied to document 28 in accordance with details of the action and of document 28 (e.g. metadata), as well as content of document 28. Application of policies 26 may thus result in the action being enabled (allowed) or disabled (denied).

A format of a policy may be formally described, for example, in terms of Boolean expressions. Each policy may be expressed in the following format:

rule::=proposed_action [symbol] metadata [symbol] policy_expr→required_protection

where (examples of actions and metadata are given, and other examples are possible):

proposed_action::=print|email|upload|save

metadata::==printer_IP|email_address|upload_IP|save_path; (each corresponding to an example of a respective proposed action)

policy_expr::=policy_condition|(policy_expr [symbol] policy_expr)|
(policy_expr [symbol] policy_expr)|( [symbol] policy_expr)

policy_condition::=text_tag|regular_expression

required_protection::=allow [allow_embellishment]
   |deny [deny_embellishment]

allow_embellishment::=log|encrypt|sign|redact| (other embellishments are possible);

and

deny_embellishment::=log|alert| (other embellishments are possible).

As used in expressions herein, ::=denotes a definition, [symbol] conjunction (and), [symbol] disjunction (or), and [symbol] negation (not).

When a policy is applicable, the metadata match the proposed action, e.g. for printing, the metadata must be a printer IP address. The policy conditions may include strings of one or more characters or valid regular expressions.

A text_tag or regular_expression may evaluate to true when the corresponding text is found anywhere in the document, or may evaluate to true when found in a particular section of the document (e.g. in a document header, footer, or title). The text_tag may be further augmented by an error tolerance, e.g. to accommodate potential errors in spelling. For example the condition of a policy save [symbol] ‘technical’_{Error=1} [symbol] ‘report’_{Error=1}→allow may be satisfied when a document contains a misspelled variant of “technical”, such as “techical” or “technicl”, with an error distance of one character (one missing or superfluous letter). For example, an error distance or tolerance may be expressed in terms of a Damerau-Levenshtein distance between the actual strings and the variant string. In addition to errors, a policy may also accommodate grammatical or syntactical variants due to language inflexions, such as stemming and lemmatization (e.g. have, had, has).

For example, whenever proposed_action and metadata match the proposed action on the document, and policy_expr evaluates to true on the document, then a specified required_protection may be applied to the proposed action.

Required protections, or allowabilities, may be divided into two broad classes, allow and deny. Protections, however, may include an optional embellishment, such that the protection may be applied along with an additional feature. For example, allow_encrypt may mean that the action is allowed; but that the document is to be encrypted prior to execution of the action. In this example, an encryption interface may be automatically activated to enable the user to complete the action. The reason for dividing graph on parts (as bi-partite graph) is that an ordering is shown that also satisfies the necessary properties but using far fewer edges. Thus, there is no ordering between some pairs of policies with the same required protection.

In general, the number of types of allowabilities may be greater than two. For example, an allowability may indicate restricted or conditional execution of an action. In accordance with some examples of automatic prioritization of policies, an embellished protection may correspond to a separate part of a multipartite graphical representation of the set of policies. On the other hand, when the embellishment merely specifies execution of an action in addition to the requested action, the embellished allowability may be classified together with the more general (unembellished) class of allowabilities.

For example, apart from allow and deny, a third type or class allowability could be used, e.g. offering an alternative action.

An example of a single policy:

save [symbol] [symbol] ‘C:\encrypted’ [symbol] ‘classified’→deny

may apply only to a proposed action to save a document containing the word “classified” outside the ‘C:\encrypted’ directory path. In such a case, the action is denied (disabled). For any other proposed action the policy may be ignored as not applicable. The result of applying such a policy is that any document containing word “classified” can only be saved into the folder “C:\encrypted” and nowhere else on the system; any document that does not contain “classified” can be saved anywhere.

Two policies may be considered to have compatible when the resulting required protections are the same, apart from embellishments. Two policies may be considered to have incompatible protections when the resulting required protections are different, apart from embellishments. Incompatibility may also result when two policies have identical protections, but the condition of one is a negation of the condition of the other (or a sub-condition of one is a negation of a sub-condition of the other—in some examples of automatic prioritization of policies, policies may be further reduced to policy primitives, e.g. aggregates of multiple simple policies, to always enable direct comparison). In the event of incompatible protections, relative priorities may be assigned to each of the two policies with incompatible protections. (The policy with the lower priority may still apply when the only the lower policy, and not the higher priority policy, applies to requested action.)

Since policy_condition evaluates as true whenever, e.g., a corresponding text string is present in the document, it is possible that more than one context-aware policy may apply to a requested action on a single document. In the event that resulting protections from two policies are incompatible, e.g. one allow and the other deny, only the protection that results from the highest priority applicable policy is applied.

For example, in the case that a set of policies is modeled such that it is forbidden to electronically mail (email) any document containing the name of a new product (e.g. product NewModel 5N). However, emailing a document that contains the words “press release” (indicating an explicitly vetted press release) is allowed. When a document contains both “press release” and “NewModel 5N”, there is a policy contradiction that may be resolved by assigning relative priorities.

The policies may be expressed as

email [symbol] ‘NewModel 5N’→deny

and

email [symbol] ‘press release’→allow,

with the latter policy being assigned a higher priority than the former.

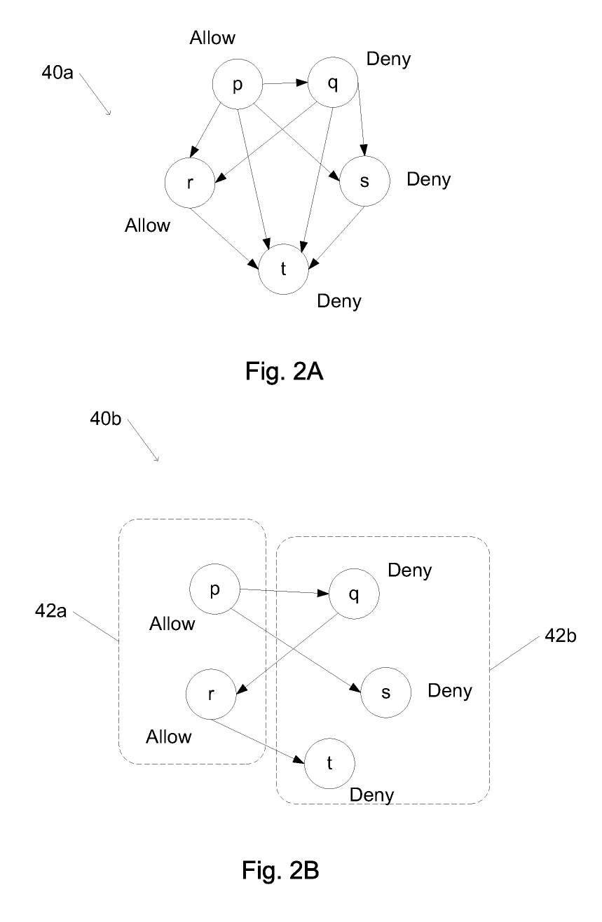

Priorities may be assigned to policies may be assigned in order to avoid conflicts when applying multiple polices. For example, pairs of policies may be ordered such that whenever both policies are applicable to a single document with different allowabilities, a relative priority is assigned to each policy. An ordering may be drawn in the form of a directed graph. FIG. 2A is a graphical representation of ordering of a set of policies for an example of automatic prioritization of policies.

Nodes (vertices) p, q, r, s, and t in graph 40a represent policies. The protection that results from application of each of the represented policies (allow or deny) is indicated next to each node. A directed path from a first node to a second node may be indicated by an arrow, or series of end-to-end arrows that points from the first node to the second. A directed path from a first node to a second node indicates that policy that is represented by the first node has a higher priority than the policy that is represented by the second node.

It may be required of the ordering that for any pair of policies with incompatible protections, e.g. allow and deny, one of the policies must have priority over the other. Thus in graph 40a, there may be a directed path from a node x to a node y, or a path from node y to node x, but not both. Thus, whenever a pair of policies may conflict there, is an unambiguous outcome. As a consequence, a graph 40a may not contain closed paths, as a closed path through nodes x and y would ambiguously indicate that both the policy corresponding to node x is both higher lower priority than the policy that corresponds to node y.

Graph 40a includes complete ordering of all nodes. Thus, graph 40a includes edges between all pairs of nodes, including those representing policies with the same allowabilities. This corresponds to arranging all policies in a list sorted from highest to lowest priority, implying that no two priorities can be equal. However, such a description may include unnecessary ordering between policies. For example, nodes p and r are ordered, even though they cannot conflict. Also, there is no need for the edge from node p to node t because there is already a directed path from node p to node t via nodes q and r.

Minimizing the number of edges may correspond to a more efficient process of setting priorities. For example, when setting a priority includes soliciting input from a policy administrator, definition of each edge in graph 40a may require a decision that is solicited from the administrator. For example, graph 40a may be reduced to a form of minimal edges.

FIG. 2B is a graphical representation of a reduced form of the graph shown in FIG. 2A In graph 40b, no edges connect pairs of nodes that correspond to policies with the same allowabilities, e.g. between nodes p and r or nodes q and s. Graph 40b is bipartite, with part 42a corresponding to allowability allow, and part 42b corresponding to allowability deny. In graph 40b, all edges connect a node in part 42a with a node in part 42b.

Priorities may be assigned to policies of a set using a constraint programming implementation of policies. A constraint programming paradigm may be based on separate modeling and solving stages. During a modeling stage, a problem domain may be described in terms of constraints and variables. During a solving stage, solutions to the problem domain may be found.

For example, the problem domain may be modeled using Boolean satisfiability (SAT) or in another manner. A SAT problem may consist of a set of variables V={v₁ . . . , vⱼ}, a set of literals L of which each is either a variable v or its negation [symbol] v, and a set of clauses C={c₁ . . . , cₖ}, where each clause cᵢ is a set of literals.

A solution to a SAT problem is a set of literals S such that l∈S [symbol] [symbol] l∉S and also for each clause C, the intersection of C and L is non-empty (in other words, a literal from the solution is found in each clause.

A clause {l₁ . . . , lⱼ} behaves like a disjunction l₁ [symbol] . . . [symbol] lⱼ because the solution must contain at least one literal from each clause in order that it be satisfied. The whole SAT behaves like a conjunction c₁ [symbol] . . . [symbol] cₖ because all clauses must be true for the SAT to be satisfied. When v∈S, v may be described as set to true in the solution, and when [symbol] v∈S, v may be described as set to false.

For example, a SAT consisting of variables {x, y, z} and clauses {{x, [symbol] z}, {x,z}, { [symbol] y, z}} corresponds to the Boolean expression (x [symbol] [symbol] z) [symbol] (x [symbol] z) [symbol] ( [symbol] y [symbol] z). The set S={x, [symbol] y, z} is a solution, because each clause has a literal from S in it. This corresponds to setting x=true, y=false, and z=true.

Hence, the modeling stage may consist of generating a SAT problem that describes a security policy and the solving stage may include providing this model to a SAT solver. The attempted action is allowed under the policy if and only if the SAT solver can find a solution. When a SAT solver based on a backtracking search terminates, it has either found a solution or proved that none exists.

In practice, a solution may be found quickly due the intelligence and efficiency of modern solvers, such as the SAT4J Java library for solving SAT and optimization problems.

In modeling security policies as an SAT, each policy may be assigned a priority value. For example, a higher number may be used to indicate a higher priority. For example, assigned priority values may range from 1 to maxprio.

In order to simplify the presentation herein, a policy may be described using a Boolean expressions involving conjunction ( [symbol] ), disjunction ( [symbol] ), implication (→), and bi-conditional ( [symbol] ), and followed by an equivalence operator and a concrete way of writing down the expression as a clause.

Each fragment of a policy (e.g. a part of a policy excluding Boolean operations) may be assigned a Boolean variable that is true if and only if the current document or proposed action matches it. For example, there may be a variable for each word appearing in a policy (e.g., “confidential”) and a variable for each proposed action (e.g. “email”). Even if a fragment appears in multiple policies, it is assigned only one variable. For example a policy

email [symbol] addr=*@gmail.com [symbol] ‘private’→deny

may be associated with variables vₑₘₐᵢₗ, v_{*@gmail.com} and vₚᵣᵢᵥₐₜₑ.

Outcomes allow and deny may be modeled by a variable v_{allow@i} whose value is true if a policy with priority i allows the corresponding proposed action and false if it disallows the proposed action. If, however, a policy with priority i does not yield an outcome of allow or deny, v_{allow@i} may be set to either true or false.

Each policy may be converted into one or more clauses, depending on its complexity. For example, the above example may be converted to

(vₑₘₐᵢₗ [symbol] v_{*@gmail.com} [symbol] vₚᵣᵢᵥₐₜₑ→ [symbol] v_{allow@2})

≡( [symbol] vₑₘₐᵢₗ [symbol] [symbol] v_{*@gmail.com} [symbol] [symbol] vₚᵣᵢᵥₐₜₑ [symbol] [symbol] v_{allow@2})

assuming that it has been assigned a priority value of 2. Hence when the left hand side of the policy evaluates to false (policy does not apply), v_{allow@2} may be either true or false. However, if the policy matches, v_{allow@2} must be set to false or else the clause has no literals in the solution.

In order to eliminate ambiguity that may remain (e.g. a variable v_{allow@i} having a value of false in a solution either because the policy requires that a corresponding action be disallowed, or because the conditions of the policy are do not match the proposed action such that that the value was set to false arbitrarily), a variable v_{applies@i} may be assigned to each priority level i. Variable v_{applies@i} may evaluate to true if and only if a policy with priority i enforces an outcome (e.g. is applicable). This may be modeled by adding a clause of the form

LHS of policy [symbol] v_{applies@i}

A final variable v_{allow} may be created to indicate whether or not the proposed action is allowed. If no rule of the policy set applies, then v_{allow} may be set to a default result of true (corresponding to allowing the proposed action by default):

$${⋀}^{i} {v}_{applies @ i} -> {v}_{allow} ≡ {v}_{applies @ 1} ⋁ K ⋁ {v}_{applies @ ma x prio} ⋁ {v}_{allow}$$

If a policy at priority level i applies, and no higher priority policy applies, the final result may be determined by policies at priority level i:

$$∀ i , {v}_{applies @ i} ⋀ ( {{⋀}^{ma x prio}}_{j = i + 1} {v}_{applies @ j} ) -> {v}_{allow} ≡ {v}_{allow @ i} 0$$

which may be modeled in terms of clauses for an arbitrary i as

[symbol] v_{applies@i} [symbol] v_{applies@i+1} [symbol] . . . [symbol] v_{applies@maxprio} [symbol] [symbol] v_{allow@i} [symbol] v_{allow}

and

[symbol] v_{applies@i} [symbol] v_{applies@i+1} [symbol] . . . [symbol] v_{applies@maxprio} [symbol] v_{allow@i} [symbol] [symbol] v_{allow}

The first of these clauses corresponds to v_{allow} being set to true when the policy at level i applies and determines that the proposed action is allowed, while every policy with priority greater than i does not apply. Similarly, the second of these clauses corresponds to v_{allow} being set to false when the policy at level i applies, and determines that the proposed action is not allowed, while every policy with priority greater than i does not apply.

The example above, with policies:

email [symbol] ‘NewModel 5N’→deny (priority 1)

and

email [symbol] ‘press release’→allow (priority 2)

may be expressed as clause. The variables used may be vₑₘₐᵢₗ, v_{NewModel}_{_{—}}_{5N}, vₚᵣₑₛₛ_{_{—}}ᵣₑₗₑₐₛₑ, v_{allow@1}, v_{allow@2}, v_{applies@1}, v_{applies@2}. and v_{allow}. The clauses may include:

[symbol] vₑₘₐᵢₗ [symbol] [symbol] v_{NewModel}_{_{—}}_{5N} [symbol] [symbol] v_{allow@1}

[symbol] vₑₘₐᵢₗ [symbol] [symbol] vₚᵣₑₛₛ_{_{—}}ᵣₑₗₑₐₛₑ [symbol] v_{allow@2}

which model the policies;

[symbol] vₑₘₐᵢₗ [symbol] [symbol] v_{NewModel}_{_{—}}_{5N} [symbol] v_{applies@1}

[symbol] vₑₘₐᵢₗ [symbol] [symbol] vₚᵣₑₛₛ_{_{—}}ᵣₑₗₑₐₛₑ [symbol] v_{applies@2}

vₑₘₐᵢₗ [symbol] [symbol] v_{applies@1}

v_{NewModel}_{_{—}}_{5N} [symbol] [symbol] v_{applies@1}

vₑₘₐᵢₗ [symbol] [symbol] v_{applies@2}

vₚᵣₑₛₛ_{_{—}}ᵣₑₗₑₐₛₑ [symbol] [symbol] v_{applies@2}

which ensure that variables v_{applies@i} are set correctly;

v_{applies@1} [symbol] v_{applies@2} [symbol] v_{allow}

which ensures that when no policy applies, the action is allowed;

[symbol] v_{applies@1} [symbol] v_{applies@2} [symbol] [symbol] v_{allow@1} [symbol] v_{allow}

[symbol] v_{applies@1} [symbol] v_{applies@2} [symbol] v_{allow@1} [symbol] [symbol] v_{allow}

which ensure that when only the first policy applies, the overall outcome is determined by the first policy; and

[symbol] v_{applies@2} [symbol] [symbol] v_{allow@2} [symbol] v_{allow}

[symbol] v_{applies@2} [symbol] v_{allow@2} [symbol] [symbol] v_{allow}

which ensure that when only the second policy applies, the overall outcome is determined by the second policy.

In accordance with this example, if a user attempts to email a document that contains the text “NewModel 5N” but not “press release”, variables vₑₘₐᵢₗ and v_{NewModel}_{_{—}}_{5N} may be set to true, while vₚᵣₑₛₛ_{_{—}}ᵣₑₗₑₐₛₑ may be set to false. The variable v_{allow} is initialized to true so that if the action is allowed a solution may be found, but if the action is not allowed it may be impossible to find a solution. An SAT solver may be instructed to find a solution. Consistency among the clauses requires that v_{allow} has to evaluate to false, in contradiction to the initial value of true which had been assigned. Therefore, no solution is possible, and the action is not allowed.

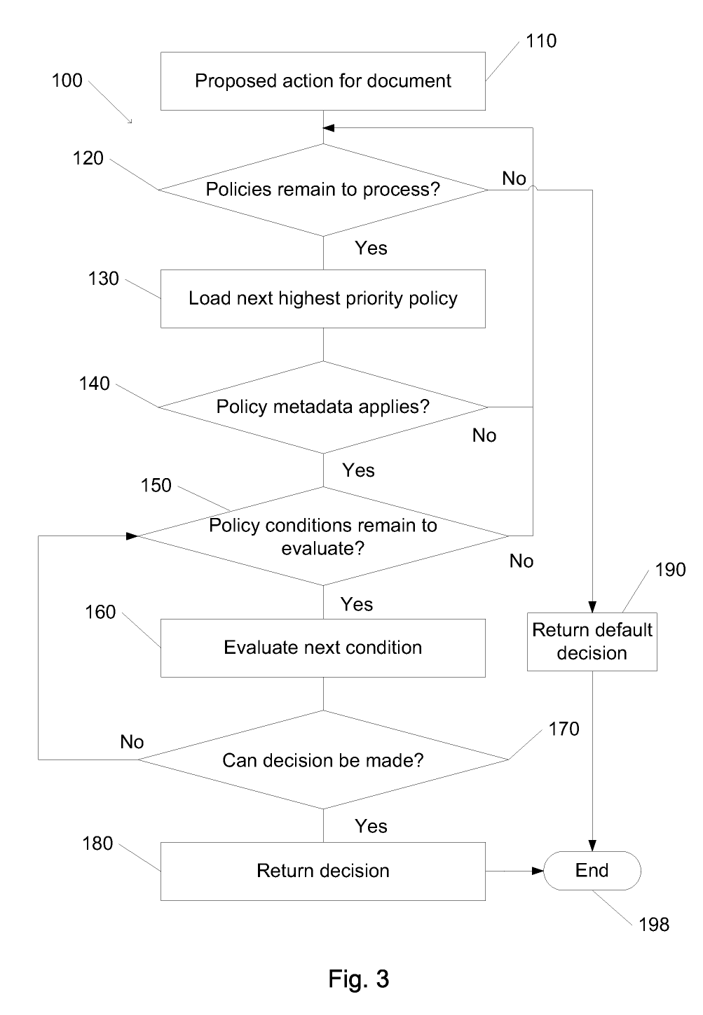

FIG. 3 is a flowchart of an example of a decision process by application of a set of policies. It should be understood with respect to this flowchart and to other flowcharts referred to herein, that the division of a method into discrete operations represented by blocks of the flowchart is for the sake of convenience and clarity only. Alternative divisions of the method into individual operations with equivalent results are possible, and should be understood as representing other examples of the method. Unless indicated otherwise, the order of the blocks in the flowchart has been selected for the sake of convenience and clarity only. Execution of operations that are represented by blocks of the flowchart in a different order or concurrently may yield equivalent results. Such reordering should be understood as representing other examples of the illustrated method.

Policy evaluation method 100 may be executed by a processor of a system for application of context-aware policies, for example, when an action is proposed to be executed with regard to a document (block 110).

If policies remain to be processed, e.g. applied to the proposed action (block 120), the highest priority remaining policy may be evaluated with respect to the proposed action, e.g. loaded into a SAT solver (block 130). Otherwise, a default decision may be made, e.g. allow the action (block 190), and the process terminated (block 198).

If the policy metadata applies to the proposed action (block 140), and a condition of the policy remains to be evaluated (block 150), the next condition may be evaluated (block 160). Otherwise, the set of policies may be examined to determine if any policies remain to be evaluated (return to block 120).

If upon evaluating the next condition, a decision may be made, e.g. by a SAT solver (block 170), the decision (e.g. to allow or disallow the proposed action) may be returned (block 180) and the process ended (block 198). Otherwise, the policy may be checked to see if a further condition remains to be evaluated (return to block 150).

In accordance with an example of automatic prioritization of policies, priorities may be assigned to a pair of policies without soliciting input from a policy administrator.

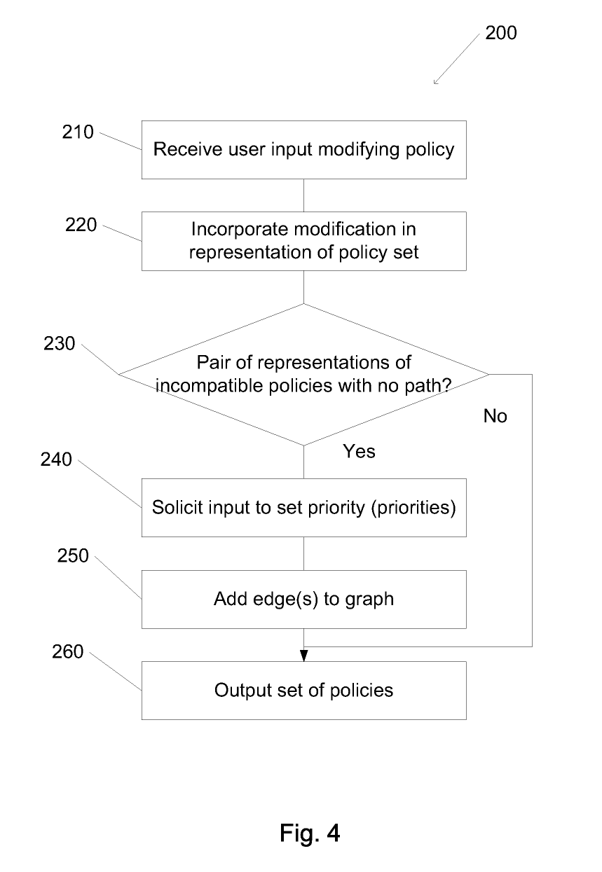

FIG. 4 is a flowchart of an example of a method for automatic prioritization of policies. Automatic prioritization method 200 may be executed, for example, by a processor of a system for managing or assisting management of context-aware policies.

Automatic prioritization method 200 may be executed when a policy administrator indicates (e.g. by operating an input device, e.g. in connection with a user interface to a processor) an intention to modify (herein understood as including creating) a set of context-aware policies.

For example, a policy administrator may input to a processor a modification (such as, for example, addition, deletion, or editing) of a policy of a set of context-aware policies (block 210).

The modification may be incorporated into a representation of the set of policies (block 220). For example, the set of policies may be represented by a graph of nodes that represent policies, and directed edges and paths that connect the nodes and that indicate relative priorities among the policies.

A transitive closure may be computed for the representation. Computing a transitive closure may identify any directed paths of contiguous edges that connect nodes. The representation may be represented by a multipartite graph in which each part corresponds to a possible allowability. In the multipartite graph, an edge may only connect nodes in different parts of the graph (since any other edges may be unnecessary, as not representing resolution of a potential conflict)

The representation may be examined to identify one or more pairs of representations of unresolved incompatible policies where the representations of the policies of the pair (e.g. a pair of nodes) are not connected by a directed path of contiguous edges (block 230). For example, a representation of such a pair may include one node in one part of the graph, and another node in another part of the graph.

If no such unresolved pair is found, then the policies of the set are automatically prioritized and the set may be output (block 260, e.g. with the set of policies being made available for evaluating requested actions).

If such an unresolved pair is found, then input may be solicited for determining the relative priorities of each such unresolved pair (block 240). For example, a policy management assistant may construct and present a suitable example action on a document that illustrates results of various prioritization options. A policy administrator may then be solicited to examine the various results and to indicate which result is preferred. As another example, an automatic application may select a prioritization (e.g. based on statistical analysis of previous administrator selections or other information).

The input decision may then be added to the representation (block 250), e.g. in the form of an edge in the graph that connects two nodes representing the policies of the pair.

The operations indicated by blocks 230 through 250 may be repeated for every pair of incompatible policies that had not yet been prioritized. In some cases, where more than one such unresolved pair exists, prioritizing one pair may automatically prioritize another previously unresolved pair, depending on the relationships between the policies. For example, prioritizing one pair may result in a formation of a directed path between a previously unresolved pair.

After prioritizing all unresolved pairs, the set of policies may be output (block 260). For example, the set of policies may be stored in a memory or data storage device for use by a processor in determining whether or not a requested action on a document may be allowed (enabled) or disallowed (denied). The set of policies may be utilized by a policy enforcement mechanism or system.

A method for automatic prioritization of policies may operate in coordination with a modeling assistant. A modeling assistant may assist a policy administrator in performing actions to add, edit, or remove a policy from the policy set.

For example, a modeling assistant may generate pertinent and exhaustive (all distinct) examples of actions, metadata, and documents, as well as the protection that application of a policy enforces on those documents. An example may be considered pertinent if it includes key words or text strings that appear in appropriate fields of the policy. An example may be considered exhaustive if it relates to all classes of documents to which the policy applies (but not every document because they could be infinite in number).

An example of a system for management of context-aware policies may include a policy editor interface. A policy administrator interacting with the policy editor interface may edit policies and assign priorities to the policies. A policy assistant application or module may also interact with a policy administrator via the policy editor interface.

For example, a policy editor interface may display the policies in the form of a table, with the policies ordered in order of their priorities (e.g. from highest to lowest priority). The ordering in the table may be equivalent to a preorder traversal of the priority graph (e.g. such as graph 40a in FIG. 2A, and graph 40b in FIG. 2B). In such an ordering, whenever a there is a ordered path in the priority graph from a first policy to a second policy, the first policy must appear earlier in the list than the second policy.

For example, a policy editor interface and a policy assistant application may include an add policy function. For example, an “add policy” function may be implemented as a wizard that presents a policy administrator with a series of choices. As a result of the policy administrator's selection, the application may determine what the added policy is, how it should interact with other policies, and whether the set of policies (or policy database) can be simplified by removing a newly redundant policy. However, changes to the set of policies may not be finalized until interaction with the application has been completed. Thus, the application may be used for exploratory modeling of policies.

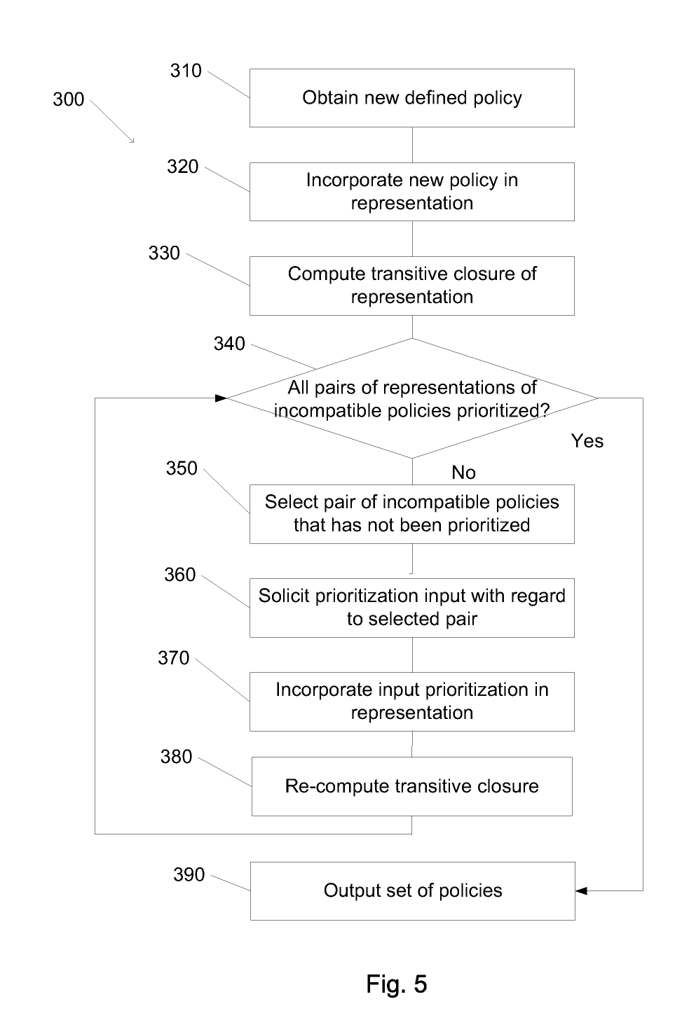

FIG. 5 is a flowchart of an example of a method for automatic prioritization of policies upon adding a policy to a set of policies. Policy addition prioritization method 300 may be performed when a policy administrator indicates an intention to add a context-aware policy to a set of context-aware policies.

Input may be obtained, e.g. from a policy administrator, to define a new policy p to be added to a set of policies (block 310). For example, a user interface may be provided that enables a policy administrator to select or input one or more of an action, metadata, conditions, or protection to define a policy.

The new policy may be incorporated into the representation of the set of policies (block 320). For example, the new policy may be represented as a node in an appropriate part (e.g. corresponding to an allowability of the policy when its condition is satisfied) of a multipartite graph.

The transitive closure (TC) of the representation may be calculated (block 330). For example, a suitable transitive closure algorithm, e.g. Warshall's algorithm, may be applied.

Analysis of the computed transitive closure may indicate whether or not all pairs of incompatible policies are prioritized (e.g. are connected by directed paths in the representation—block 340). If so, the set of policies may be output (block 390).

If one or more pairs of incompatible policies that have not been prioritized are present, one of the pairs may be selected (block 350). Input regarding prioritization of the selected pair may be solicited (block 360). For example, input may be solicited from a policy administrator, e.g. by presenting the administrator with an example with regard to which the administrator may indicate a preferred result.

The input prioritization may be incorporated into the representation (block 370). For example, the input prioritization may be incorporated as an edge that connects two nodes of the graph that represent that selected pair. The transitive closure of the representation may then be recomputed or updated (block 380).

The transitive closure may then be analyzed again to check for the presence of incompatible pairs of policies that have not been prioritized (return to block 340).

As another example of automatic prioritization of a set of context-aware policies, a policy of a set of context-aware policies may be removed or deleted.

For example, prior to removal of policy p, two other policies of the set, q and r, may have been prioritized by a path that includes p, e.g. q . . . p . . . r. In this case, upon removal of p, policies q and r may be explicitly prioritized automatically. For example, an edge that connects nodes that correspond to policies q and r may be automatically added to the representation.

As another example of managing a set of context-aware policies, a policy of a set of context-aware policies may be edited. Editing a policy may be decomposed into separate operations of deletion of the existing policy followed by addition of the edited policy.

In accordance with examples of automatic prioritization of policies, a computer program application stored in non-volatile memory or computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein, such as an example of a method for management of context-aware policies.

The computer-readable medium may be a non-transitory computer-readable media including all forms and types of memory and all computer-readable media except for a transitory, propagating signal. In one implementation, external memory may be the non-volatile memory or computer-readable medium.

We claim:

1. A method comprising:
obtaining input to modify a policy of a set of self-consistent document policies, a policy of the set being applicable to a requested action on a document so as to indicate an allowability of the requested action when a condition of the policy is satisfied, the condition being at least partly related to a content of the document, and when a plurality of policies of the set are applicable to the requested action on the document, allowability of the requested action being determined by the allowability that is indicated by application of the applicable policy with a highest priority;
incorporating the modification into a representation that corresponds to a multipartite graph, wherein each policy is representable by a node on the multipartite graph, each node being located in a part of the multipartite graph that corresponds to the allowability that is indicated by the policy to which the node corresponds, and wherein two nodes are connectable by an edge that indicates a relative priority between the policies that correspond to the two nodes; and
computing a transitive closure of the representation so as to identify any paths connecting pairs of nodes, each path including one or more contiguous edges; and
when two policies that indicate different allowabilities are applicable to a single requested action on a single document such that the conditions of both of the policies are concurrently satisfied, and when the nodes that correspond to the two policies are connected by one of the identified paths, automatically assigning a relative priority to the two policies as indicated by the path.

2. The method of claim 1 comprising when said nodes that correspond to the two policies are not connected by said path of one or more contiguous edges, ensuring that a relative priority is assigned to the two policies.

3. The method of claim 2, wherein ensuring that a relative priority is assigned to the two policies comprises soliciting input from a policy administrator.

4. The method of claim 3, wherein soliciting input comprises automatically generating an example of a result of performance of the requested action of the two polices on an example of a document in accordance with a possible relative priority of the two policies, such that received input indicates a preferred result.

5. The method of claim 1, wherein the multipartite graph is bipartite, one part of the bipartite graph corresponding to an allowability to allow execution of the requested action, and the other part of the bipartite graph corresponding to an allowability to deny execution of the requested action.

6. The method of claim 1, wherein the input comprises an indication to add a policy to the set, to delete a policy from the set, or to edit a policy of the set.

7. The method of claim 1, wherein application of a policy of the set of policies to a requested action comprises requiring performance of an additional action.

8. The method of claim 1, wherein applicability of a policy of the set of policies to the requested action depends on metadata.

9. The method of claim 8, wherein the metadata comprises a metadata selected from a group of metadata consisting of: a printer address, an email address, an upload address, and a save path.

10. The method of claim 1, wherein the condition comprises inclusion of a character string within the document.

11. A non-transitory computer readable medium having stored thereon instructions that when executed by a processor will cause the processor to perform the method of:
obtaining input to modify a policy of a set of self-consistent document policies, a policy of the set being applicable to a requested action on a document so as to indicate an allowability of the requested action when a condition of the policy is satisfied, the condition being at least partly related to a content of the document, and when a plurality of policies of the set are applicable to the requested action on the document, allowability of the requested action being determined by the allowability that is indicated by application of the applicable policy with a highest priority;
incorporating the modification into a representation that corresponds to a multipartite graph, wherein each policy is representable by a node on the multipartite graph, each node being located in a part of the multipartite graph that corresponds to the allowability that is indicated by the policy to which the node corresponds, and wherein two nodes are connectable by an edge that indicates a relative priority between the policies that correspond to the two nodes;
computing a transitive closure of the representation so as to identify any paths connecting pairs of nodes, each path including one or more contiguous edges; and
when two policies that indicate different allowabilities are applicable to a single requested action on a single document such that the conditions of both of the policies are concurrently satisfied, and when the nodes that correspond to the two policies are connected by one of the identified paths, automatically assigning a relative priority to the two policies as indicated by the path.

12. The non-transitory computer readable medium of claim 11, further comprising instructions to perform the method of when said nodes that correspond to the two policies are not connected by said path of one or more contiguous edges, ensuring that a relative priority is assigned to the two policies.

13. The non-transitory computer readable medium of claim 12, wherein ensuring that a relative priority is assigned to the two policies comprises soliciting input from a policy administrator.

14. The non-transitory computer readable medium of claim 13, wherein soliciting input comprises automatically generating an example of a result of performance of the requested action of the two polices on an example of a document in accordance with a possible relative priority of the two policies, such that received input indicates a preferred result.

15. The non-transitory computer readable medium of claim 11, wherein the multipartite graph is bipartite, one part of the bipartite graph corresponding to an allowability to allow execution of the requested action, and the other part of the bipartite graph corresponding to an allowability to deny execution of the requested action.

16. The non-transitory computer readable medium of claim 11, wherein the input comprises an indication to add a policy to the set, to delete a policy from the set, or to edit a policy of the set.

17. The non-transitory computer readable medium of claim 11, wherein the requested action is selected from a group of actions consisting of: printing, saving, emailing, and uploading.

18. The non-transitory computer readable medium of claim 11, wherein applicability of a policy of the set of policies to the requested action depends on metadata.

19. The non-transitory computer readable medium of claim 18, wherein the metadata comprises a metadata selected from a group of metadata consisting of: a printer address, an email address, an upload address, and a save path.

20. The non-transitory computer readable medium of claim 11, wherein the condition comprises inclusion of a character string within the document.
